(19) United States
(12) Patent Application Publication
(10) Pub. No.: US 2013/0088934 A1
(43) Pub. Date: Apr. 11, 2013

(54) Drilling Mud Agitator With Shaft Retainer

(71) Applicant: Louis Charles Gouin, Houston, TX (US)

(72) Inventor: Louis Charles Gouin, Houston, TX (US)

(73) Assignee: PROCESS SOLUTIONS INTERNATIONAL, Houston, TX (US)

(21) Appl. No.: 13/269,736

(22) Filed: Oct. 10, 2011

(51) Int. Cl. B01F 7/22

(52) U.S. Cl. 366/282

(57) ABSTRACT

A mechanism secures a mud agitator motor on top of a man-way cover on a mud tank. The mechanism includes a retractable shaft retainer element arranged to engage a retainer block affixed to the agitator shaft. A pair of hemi-cylindrical coupling halves couple the agitator motor shaft to the agitator shaft. The retractable shaft retainer element, once engaged with the retainer block, secures the agitator shaft. The coupling halves can then be quickly and easily removed, and the motor can then be removed for repair or replacement.

### FIELD OF THE INVENTION

The present invention relates generally to the field of drilling mud systems and, more particularly, to a drilling mud agitator assembly including a shaft retainer that permits disassembly of the agitator shaft from outside the agitator tank.

### BACKGROUND OF THE INVENTION

The present invention relates to a device for agitating drilling mud having particulate solids entrained therein, such as for example drill cuttings and various drilling mud additives. In operation, such a device is typically mounted atop a mud tank in which one or a plurality of agitating devices may extend.

As described in U.S. Pat. No. 4,516,860 to van der Laan et al., drilling mud is commonly used in oil and gas drilling operations to cool and lubricate the drill bit and flush drill cuttings from the bore hole back up to the surface. Drilling mud must have an adequately high specific weight so that the column of drilling mud controls the liquids and/or gases in the formation on the corresponding depth without danger of blow outs. Further, viscosity of the drilling mud should be higher than that of water, so that the drill cuttings can be entrained in the rising flow of drilling mud in the annulus around the drill pipe. At the surface, the drill cuttings are removed from the drilling mud in a several-step operation. In one step in this operation, it is essential to agitate the drilling mud to keep the drill cuttings from separating out of suspension in the drilling which would clog up the operation.

For this step, drilling systems commonly include a mud tank provided with an agitator. The agitator typically comprises a motor mounted on a mounting plate on top of the mud tank. A shaft is coupled to the motor and extends down through the mounting plate into the mud tank to a level sufficient to be immersed in the mud/drill cuttings suspension. An impeller is mounted to the end of the shaft so that by rotating the impeller, the mud is agitated and the drill cuttings are prevented from settling out.

The agitator system shown and described in U.S. Pat. No. 5,944,418 to Orr et al. illustrates one structure of the coupling of the motor, shaft, and impeller. In that system, a motor is mounted on the top of a cover. Various types of motors might be employed, such as an electric motor. Extending from the motor is an agitator shaft which passes through the cover and is rotated by the motor. The agitator shaft lies generally along the axis of the cylindrical tank. Extending radially outward from the agitator shaft is a plurality of impeller blades.

Orr et al. purport to keep the drilling mud the drill cuttings in good mixture without any problems, and without the high viscosity and the high specific weight of the drilling mud, and the high weight of the for instance heavy clay and/or rock particles of the drill cuttings could cause a separation of the drill cuttings and the drilling mud.

A difficulty arises when maintenance must be performed on the system within the mud tank or repair or replacement of the agitator motor. The typical system, as shown in described in Orr et al., requires access into the mud tank if maintenance is to be performed on the agitator. This requires draining the mud from the mud tank and then permitting a workman to enter the mud tank to perform the required operation. Or, if the agitator motor is to be repaired or replacement, access must be made into the mud tank to de-couple the impeller blades from the end of the shaft so that the shaft can be withdrawn through the cover. This is not only time consuming, it places the workman in danger.

Thus, there remains a need for a system that allows the system to be secured so that the maintenance operation can be performed on the outside the tank. The present invention is directed to fulfilling that need in the art.

### SUMMARY OF THE INVENTION

The present invention addresses these and other needs in the art by providing a mechanism for securing the agitator motor on top of the man-way cover for the mud tank. The mechanism includes a retractable shaft retainer arranged to engage a retainer block affixed to the agitator shaft. A pair of hemi-cylindrical coupling halves couple the agitator motor shaft to the agitator shaft.

The retractable shaft retainer, once engaged with the retain block, secures the agitator shaft. The coupling halves can then be quickly and easily removed, and the motor can then be removed for repair or replacement.

These and other features and advantages of the present invention will be apparent to those of skill in the art from a review of the following detailed description.

### BRIEF DESCRIPTION OF THE DRAWING FIGURES

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a perspective view of a drilling mud agitator with a shaft retainer in accordance with the present invention.

FIG. 2 is a detail perspective view of the agitator of FIG. 1, with the shaft retainer withdrawn so that the agitator system is free to operate normally.

FIG. 3 is a perspective view of the agitator system of FIG. 1 with the shaft retainer engaged for maintenance on the agitator drive.

### DETAILED DESCRIPTION OF A PREFERRED EMBODIMENT

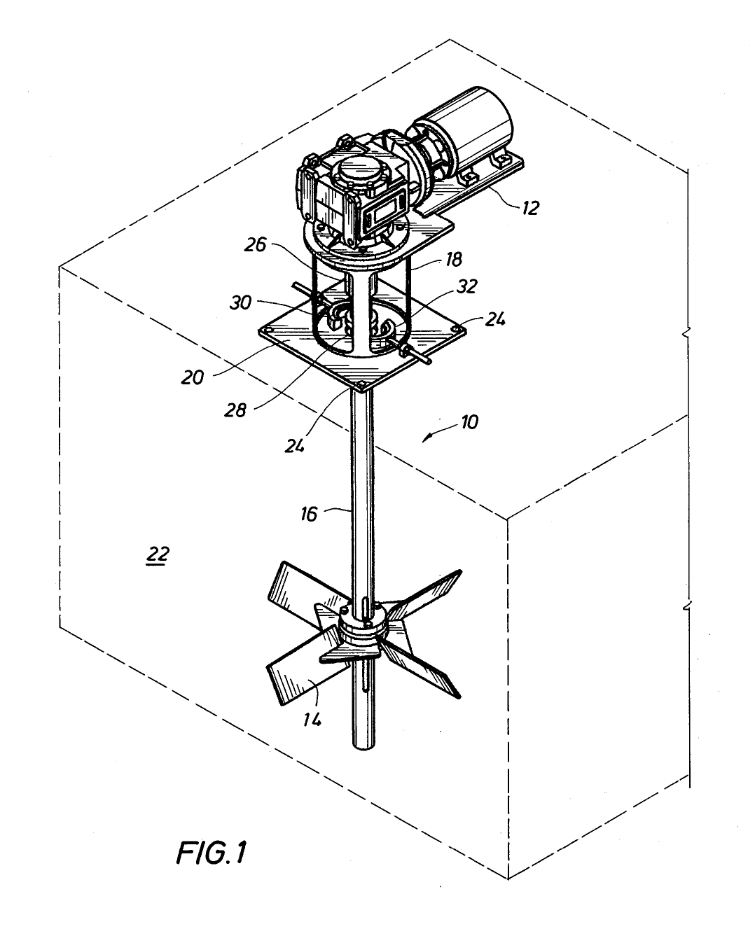

FIGS. 1, 2, and 3 depict an agitator system 10 in accordance with the teachings of the present invention. The system primarily comprises a gearbox/motor assembly 12, an impeller 14, both coupled together with an agitator shaft 16. The gearbox/motor assembly 12 is mounted on an open work pedestal 18 which is affixed to a cover plate 20. The cover plate is secured to the top of a mud tank 22, which is shown in FIG. 1 as having flat rectangular sides for illustration purposes only. Preferably, the mud tank 22 is a cylindrical tank with a round bottom so that the tank does not present any dead zones for the free flow of agitated mud within the tank. The cover plate 20 is preferably removably mounted to the top of the tank 22 with a set of screws 24, for example.

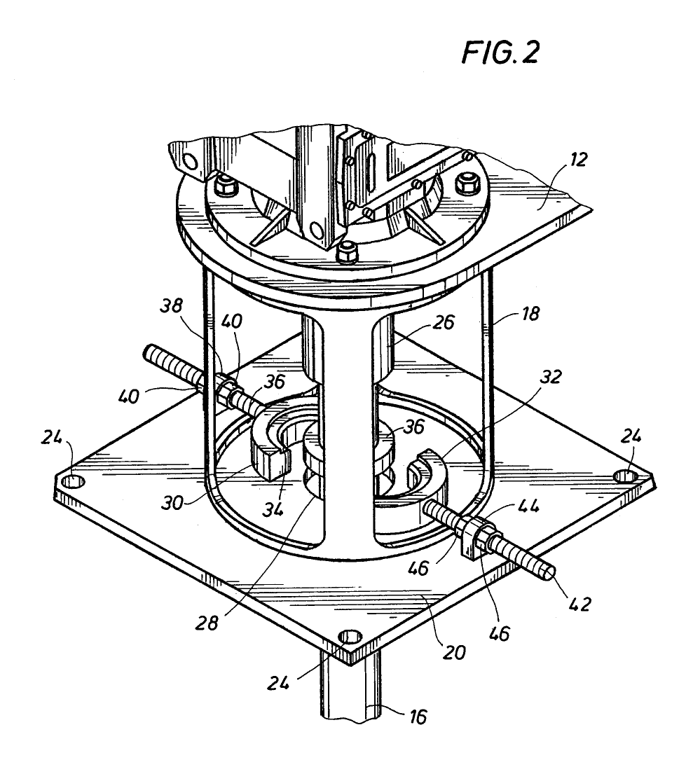

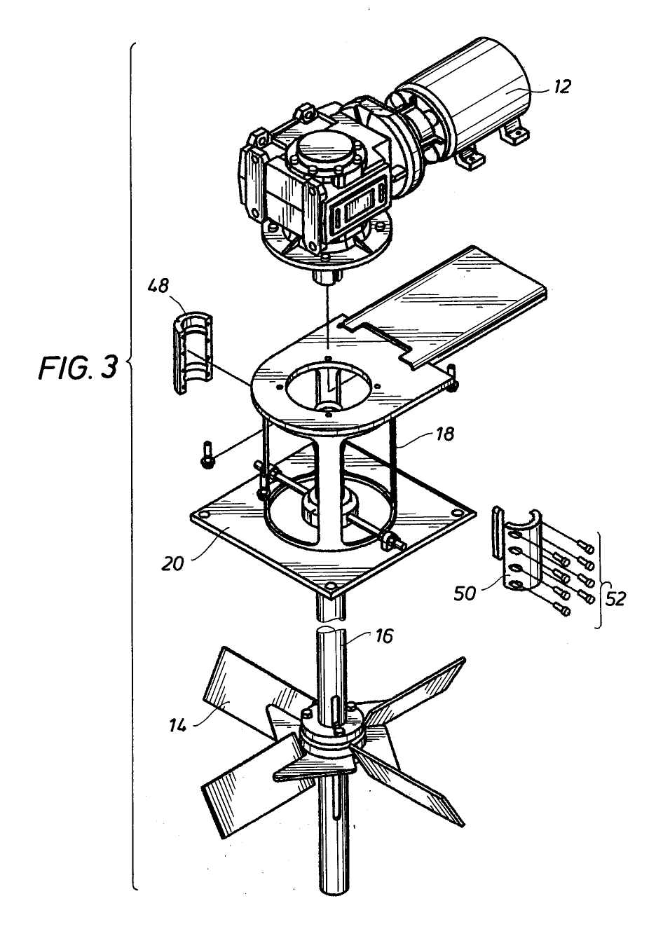

The gearbox/motor assembly 12 is preferably secured to the agitator shaft 16 with a shaft coupling 26, shown more clearly in FIGS. 2 and 3. The agitator shaft 16 extends through a hole 28 in the cover plate 20. Thus, without the present invention, decoupling the gearbox/motor assembly 12 from the agitator shaft 16 by removing the coupling would result in the agitator shaft falling through the hole 28 into the tank. To alleviate this problem, a shaft retainer comprising a first retainer half 30 and a second retainer half 32, are operationally mounted onto the cover plate 20. Each of the first and second retainer halves comprises a substantially semi-circular element with an upwardly depending notch 34 formed therein to mate with a retainer block 36. The retainer block 36 is affixed to the agitator shaft 16 such as for example by welding, or it may be otherwise secured to the shaft 16.

The first retainer half 30 is affixed to a threaded rod 36. The threaded rod passes through a flange 38 and is held in place by a pair of nuts 40. Similarly, the second retainer half 32 is affixed to a threaded rod 42, which passes through a flange 44 and is held in place by a pair of nuts 46. To operate the shaft retaining mechanism, the nuts 40 and 46 are loosened, the retainer halves 30 and 32 are moved inward into engagement with the retainer block 36, and the nuts are then re-tightened. This is the position of the shaft retaining mechanism shown in FIG. 3.

It will be apparent to those of skill in the art that many different kinds of mechanisms may be used to move the retainers back and forth within the scope and spirit of this invention. Further, many different kinds of mechanisms may be employed to engage the retainers with the retainer block. The preferred embodiment, described above, has the advantage of being simple, inexpensive, easy to use, and robust.

Once the shaft retaining mechanism is engaged as just described, the shaft coupling 26 can be removed. The shaft coupling 26 preferably comprises a first, hemi-cylindrical coupling half 48 and a second, hemi-cylindrical coupling half 50, preferably releasably held together with a set of screws 52. The pedestal 18 is made in an open-work arrangement to provide adequate room for the workman to gain access to the shaft coupling with tools.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A shaft retainer for a drilling mud agitator system, the drilling mud agitator system including an assembly comprising a gearbox and a motor, an impeller, and an agitator shaft joining the gearbox/motor assembly to the impeller, the drilling mud agitator system arranged to agitate drilling mud within a mud tank having an interior and an exterior, the shaft retainer comprising:
a. a movable retainer element arranged for back and forth horizontal motion from a first, supporting position to a second, released position; and
b. a retainer block affixed to the agitator shaft, the retainer element adapted to releasably engage the retainer block in the first position thereby vertically supporting the agitator shaft and impeller when they are decoupled from the assembly comprising a gearbox and a motor, and disengage the retainer block in the second position, wherein the shaft retainer is mounted on the exterior of the mud tank.

2. The shaft retainer of claim 1, wherein the retainer element comprises:
a. a first retainer half; and
b. a second retainer half.

3. The shaft retainer of claim 2, wherein the first retainer half comprises a first semi-circular element including a first upwardly depending notch and wherein the second retainer half comprises a second semi-circular element including a second upwardly depending notch.

4. The shaft retainer of claim 3, wherein the first and second notches are configured to mate with the retainer block.

5. The shaft retainer of claim 2, further comprising means to move the first and second retainer halves.

6. The shaft retainer of claim 5, further comprising a cover plate releasably affixed to the mud tank.

7. The shaft retainer of claim 6, wherein the means to move the first and second retainer halves comprises:
a. a first threaded member affixed to the first retainer half;
b. a first flange affixed to the cover plate, the first flange configured to receive the first threaded member therethrough;
c. a first pair of nuts to releasably secure the first threaded member to the first flange;
d. a second threaded member affixed to the second retainer half;
e. a second flange affixed to the cover plate, the second flange configured to receive the second threaded member therethrough; and
f. a second pair of nuts to releasably secure the second threaded member to the second flange.

8. The shaft retainer of claim 1, further comprising a shaft coupling joining the assembly comprising a gearbox and a motor to the agitator shaft.

9. The shaft retainer of claim 8, wherein the shaft coupling comprises a first hemi-cylindrical coupling half and a second hemi-cylindrical coupling half releasably coupled to the first coupling half.

10. A shaft retainer for a drilling mud agitator system, the drilling mud agitator system including an assembly comprising a gearbox and a motor, an impeller, and an agitator shaft joining the gearbox/motor assembly to the impeller, the drilling mud agitator system arranged to agitate drilling mud within a mud tank having an interior and an exterior, the shaft retainer comprising:
a. a movable retainer element comprising
i. a first retainer half comprising a first semi-circular element including a first upwardly depending notch; and
ii. a second retainer half comprising a second semi-circular element including a second upwardly depending notch; and
b. a retainer block affixed to the agitator shaft, the retainer element adapted to releasably engage the retainer block in the first position thereby vertically supporting the agitator shaft and impeller when they are decoupled from the assembly comprising a gearbox and a motor, and disengage the retainer block in the second position, wherein the shaft retainer is mounted on the exterior of the mud tank.

11. The shaft retainer of claim 10, wherein the first and second notches are configured to mate with the retainer block.

12. The shaft retainer of claim 11, further comprising:
a. a cover plate releasably affixed to the mud tank; and
b. means to move the first and second retainer halves, the means to move the first and second retainer halves comprising:
i. a first threaded member affixed to the first retainer half;
ii. a first flange affixed to the cover plate, the first flange configured to receive the first threaded member therethrough;
iii. a first pair of nuts to releasably secure the first threaded member to the first flange;
iv. a second threaded member affixed to the second retainer half;
v. a second flange affixed to the cover plate, the second flange configured to receive the second threaded member therethrough; and
vi. a second pair of nuts to releasably secure the second threaded member to the second flange.
